(19) United States
(12) Patent Application Publication
(10) Pub. No.: US 2013/0311289 A1
(43) Pub. Date: Nov. 21, 2013

(54) DISPLAY DEVICE, IMAGE DISPLAY SYSTEM, AND METHOD FOR DISPLAYING IMAGE

(71) Applicant: Tetsuya Nakabayashi, Osaka (JP)

(72) Inventor: Tetsuya Nakabayashi, Osaka (JP)

(73) Assignee: SHARP KABUSHIKI KAISHA, Osaka (JP)

(21) Appl. No.: 13/982,406

(22) PCT Filed: Jan. 24, 2012
(86) PCT No.: PCT/JP2012/051393

§ 371 Date: Jul. 29, 2013

(30) Foreign Application Priority Data
Jan. 31, 2011 (JP) 2011-017700

(51) Int. Cl. G06Q 30/02

(52) U.S. Cl. CPC G06Q 30/0241
USPC 705/14.54; 705/14.4

(57) ABSTRACT

Provided is a system whereby improved effects of advertisement are anticipated. An advertising system (100) includes a server (130) and terminals (140). The server (130) and the terminals (140) are respectively connected to the Internet (150). Servers (110, 120) are also connected to the Internet (150). One of a terminal (140A) and a terminal (140B) repeatedly displays images that have been downloaded from the server (130) in two screens such that each advertising image is displayed in each of two out of three or more directions.

### TECHNICAL FIELD

The present invention relates to an image display control in a display device that can display a plurality of screens.

### BACKGROUND ART

So-called dual view liquid crystal displays and triple view liquid crystal displays are known as devices that can display a plurality of screens. The dual view liquid crystal panel can simultaneously display two different images depending on viewing angles.

Japanese Patent Application Laid-Open Publication No. 2009-98537 (Patent Document 1) discloses a display device that is used for a display part of an electronic device and that can display images with different viewing angles depending on images to be displayed without using a complex mechanism.

Japanese Patent Application Laid-Open Publication No. 2007-293100 (Patent Document 2) discloses a technology for realizing the dual view display in a rear projection display device with a simple configuration.

WO2006/051971 Pamphlet (Patent Document 3) discloses an advertisement delivery system for providing a highly effective new advertisement delivery technology.

### RELATED ART DOCUMENTS

### Patent Documents

Patent Document 1: Japanese Patent Application Laid-Open Publication No. 2009-98537

Patent Document 2: Japanese Patent Application Laid-Open Publication No. 2007-293100

Patent Document 3: WO2006/051971 Pamphlet

### SUMMARY OF THE INVENTION

### Problems to be Solved by the Invention

With the technology disclosed in Patent Document 3, the user needed to negotiate with a company that seeks to place an advertisement, and the user also needed to register an advertisement image to be displayed on a network for presentation to the company. When the advertisement is displayed, a terminal of the user was occupied by the displayed advertisement.

Thus, there is a need for a display device that can display an advertisement in a simple manner without causing the display of the terminal to be occupied by the advertisement.

In another aspect, there is a need for a display system that allows an advertisement to be registered with ease when the advertisement is to be displayed in a display device.

In another aspect, there is a need for a method to display an advertisement with ease without causing the display of the terminal to be occupied by the advertisement.

In yet another aspect, there is a need for a method to register an advertisement with ease when the advertisement is to be displayed in a display device.

### Means for Solving the Problems

A display device according to one embodiment includes: a display part configured to display screens in three or more directions; an accessing part configured to access an image control apparatus by using data for identifying a user of the display device, the image control apparatus being connected to a communication network to send an image to the display device; a selecting part configured to select at least one image provider; a downloading part configured to download, from the image control apparatus, an advertising image for each image provider selected by the selecting part; a storage part configured to store the advertising image that has been downloaded; and a control part configured to control the display part such that each advertising image is displayed in each of two directions out of the three or more directions.

It is preferable that the display device further include a detection part configured to detect a movement of the display device. When a movement of the display device is detected, the control part causes the display part to display each advertising image.

It is preferable that the display device further include a deletion notification part configured to notify the image control apparatus of a deletion of the advertising image that has been downloaded.

It is preferable that the display device further include a detecting part configured to detect a position of the display device, and a searching part configured to conduct a search for an image provider that is present within a prescribed range from said position. The control part causes the display part to display an advertising image for an image provider found in the search.

According to another embodiment, an image display system is provided. The image display system includes: a display device; and an image control apparatus that is connected to a communication network to send an image to the display device. The display device includes: a display part configured to display screens in three or more directions; an accessing part configured to access the image control apparatus by using data for identifying a user of the display device; a selecting part configured to select at least one image provider; a downloading part configured to download an advertising image for each image provider selected by the selecting part from the image control apparatus; a storage part configured to store the advertising image that has been downloaded; and a control part that controls the display part so as to display each advertising image in each of two directions out of the three or more directions.

It is preferable that the image display system further include a detecting part configured to detect a movement of the display device. When a movement of the display device is detected, the control part causes the display part to display each advertising image.

It is preferable that the display device further include a deletion notification part configured to notify the image control apparatus of a deletion of the advertising image that has been downloaded.

It is preferable that the display device further include a detecting part configured to detect a position of the display device, and a search part configured to conduct a search for an image provider that is within a prescribed range from the position. The control part causes the display part to display an advertising image for an image provider found in the search.

According to another embodiment, a method for displaying images in a display device configured to display screens in three or more directions is provided. The method includes: accessing an image control apparatus by using data for identifying a user of the display device, the image control apparatus being connected to a communication network to send an image to the display device; selecting at least one image provider; downloading, from the image control apparatus, an advertising image for each image provider selected in the selecting step; storing the advertising image that has been downloaded; and displaying each advertising image in each of two directions out of the three or more directions.

### Effects of the Invention

In one aspect, it is possible to display an advertisement in a simple manner without causing the display of the terminal to be occupied by the advertisement.

In one aspect, it becomes easier to register an advertisement when the advertisement is to be displayed in a display device.

The above-mentioned and other objects, features, aspects, and advantages of the present invention will become apparent from detailed descriptions below that are to be understood in relation to the appended drawings.

### BRIEF DESCRIPTION OF THE DRAWINGS

FIG. 1 is a diagram showing a configuration of an advertisement system 100.

FIG. 2 is a diagram showing a terminal 140 displaying three screens.

FIG. 3 is a block diagram showing functions realized by a server 130.

FIG. 4 is a block diagram showing a hardware configuration of a computer system 400.

FIG. 5 is a block diagram showing a configuration of functions realized by the terminal 140.

FIG. 6 is a block diagram showing a hardware configuration of the terminal 140.

FIG. 7 schematically shows an example of data storage in a hard disk 450 of the server 130.

FIG. 8 is a diagram showing an image download history of each terminal.

FIG. 9 is a flowchart that shows a part of a series of processes executed by a CPU 610 of the terminal 140.

FIG. 10 is a flowchart that shows a part of a series of processes executed by a CPU 410 of the server 130.

FIG. 11 is a flowchart that shows a part of a series of processes executed by the CPU 410 to update an advertising fee in accordance with an advertising period.

FIG. 12 is a flowchart showing processes executed by the CPU 410 for sending a notification from the server 130 to the terminal 140 when a company cancels the advertisement.

FIG. 13 is a diagram showing images displayed on screens 220 and 230 that are viewed by people other than the user of the terminal 140, out of three screens that can be displayed by the terminal 140.

FIG. 14 is a diagram showing a schematic configuration of a system 1200.

FIG. 15 is a diagram showing how screens are displayed by a terminal 1240 that can display four screens.

FIG. 16 is a block diagram showing a configuration of functions realized by a server 1230.

FIG. 17 is a block diagram showing a configuration of functions realized by the terminal 1240.

FIG. 18 schematically shows an example of data storage in the hard disk 450.

FIG. 19 is a diagram showing an example of history database for games downloaded by users.

FIG. 20 is a flowchart showing processes executed by a CPU 410 of a computer system that functions as the server 1230.

FIG. 21 is a flowchart 1 that shows steps of the process executed by a CPU 610 that realizes functions of the terminal 1240.

FIG. 22 is a flowchart 2 that shows steps of the process executed by the CPU 610 that realizes functions of the terminal 1240.

### DETAILED DESCRIPTION OF EMBODIMENTS

Below, embodiments of the present invention will be explained with reference to figures. In the descriptions below, the same reference characters are given to the same components. The names and functions thereof are the same. Therefore, detailed descriptions thereof will not be repeated.

### Embodiment 1

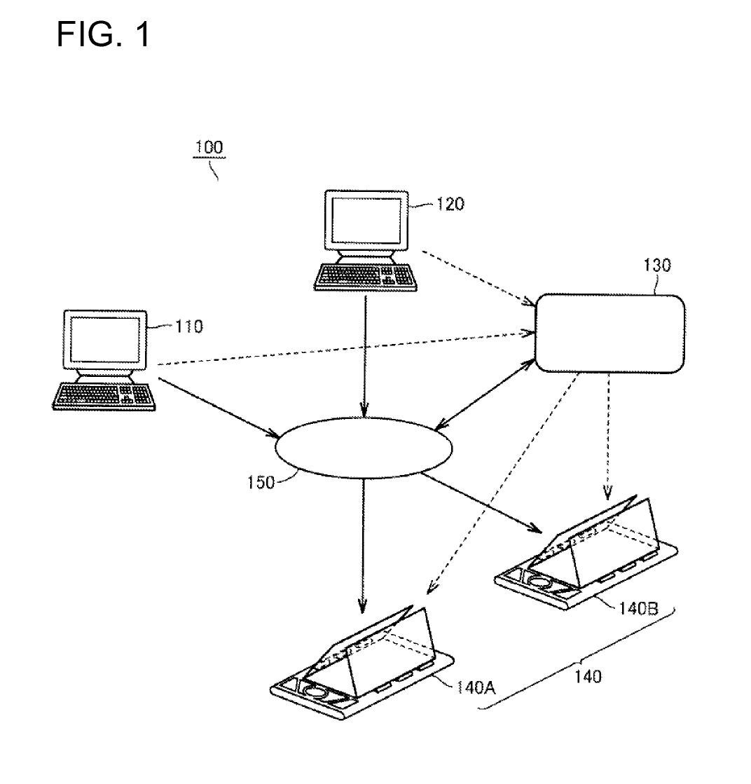

An advertisement system of Embodiment 1 of the present invention will be explained with reference to FIG. 1. FIG. 1 is a diagram showing a configuration of an advertisement system 100. The advertisement system 100 includes at least a server 130 and terminals 140. The server 130 and the terminals 140 are respectively connected to internet 150. Servers 110 and 120 are also connected to the internet 150.

The servers 110 and 120 are owned by client companies of the advertisement. The server 130 receives advertising videos or images from the client companies, and distributes the videos or images. In one aspect, terminals 140A and 140B are configured as portable information devices. Below, the terminal 140A and the terminal 140B may collectively be referred to as a terminal 140.

In one aspect, a first company that owns the server 110 sends advertising video data to the server 130, and the server 130 registers the video data. Similarly, the first company that owns the server 120 sends advertising video or image data for the company to the server 130, and the server 130 registers the data.

The user of the terminal 140 selects, from the server 130 connected to the internet 150, at least one company for which the user wants to receive advertisement (the first company and the second company, for example), and downloads each video or image data from the server 130. There is no special limitation on the number of companies that can be selected. When the user of the terminal 140 allows one screen to display advertisement for one company, for example, the user can select as many companies as the number of screens that can be displayed by the terminal 140. In the actual situation, at least one of the screens displayed by the terminal 140 is often used by the user for other purposes (such as displaying e-book or inputting texts), and therefore, in one aspect, it is preferable that the number of companies that can be selected be set to one less than the number of screens that can be displayed by the terminal 140.

When the server 130 detects that the advertising video or image was downloaded from a company to the terminal 140, the server 130 makes a payment for the advertising fee received from the company to an account that is associated with the terminal 140.

When using the advertising services, the first company that owns the server 110 and the second company that owns the server 120 respectively pay initial fees for advertisement, which were set by the administrator of the server 130 in advance. Thereafter, every time the advertisement is downloaded to the terminal 140, the server 130 charges an advertising fee, which has been set in advance per download, to the client of the advertisement.

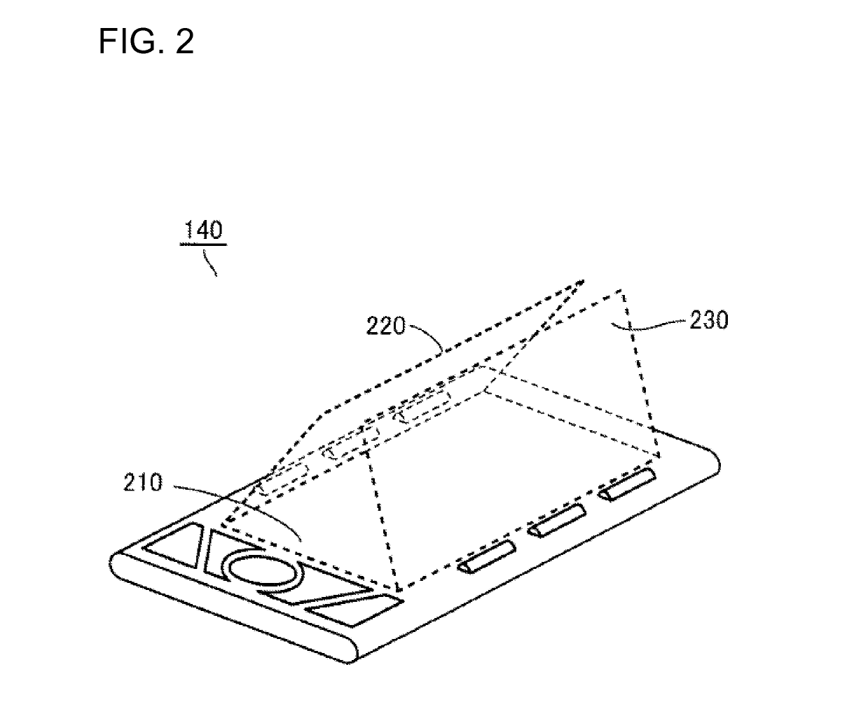

With reference to FIG. 2, the terminal 140 of one embodiment of the present invention will be explained. FIG. 2 is a diagram showing how the terminal 140 displays three screens. In one aspect, the terminal 140 can simultaneously display three screens, which are a screen 210, a screen 220, and a screen 230. For example, the screen 210 is viewed by the user that holds the terminal 140. The screen 220 is viewed by another person that is on the left side of the terminal 140. The screen 230 is viewed by yet another person that is on the right side of the terminal 140.

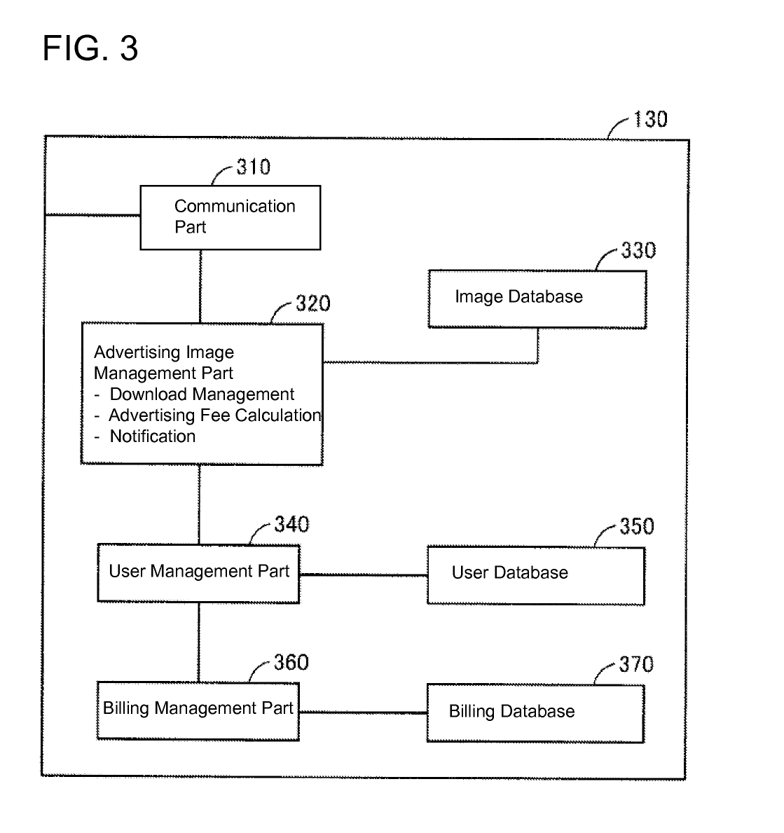

With reference to FIG. 3, a configuration of the server 130 of the present embodiment will be explained. FIG. 3 is a block diagram showing functions realized by the server 130. The server 130 includes a communication part 310, an advertising image management part 320, image database 330, a user management part 340, user database 350, a billing management part 360, and billing database 370.

The communication part 310 is configured to communicate with the servers 110 and 120, and the terminals 140A and 140B through the internet 150. The communication may be wire communication or wireless communication.

In one aspect, the advertising image management part 320 manages the download of advertising images, calculates advertising fees, and sends notifications to administrators of the servers 110 and 120 or the terminal 140. Specifically, the advertising image management part 320 receives an order of an advertisement from a client (such as the first company that operates the server 110, or the second company that operates the server 120), and registers each data for identifying the company and the advertising image thereof. The advertising image management part 320 also calculates advertising fees to be paid to each terminal 140A or 140B, based on the download history of videos and images by the terminal 140A or 140B. In another aspect, the advertising image management part 320 notifies the terminal 140 of a change or cancellation of videos or images that can be downloaded to the terminal 140, based on communications from the server 110 or the server 120.

The image database 330 stores the advertising image sent from the server 110 or the server 120 in association with the client company of the advertisement. The advertising image may be a video or a still image. The audio data may be added to the image.

The user management part 340 manages users of the advertising system 100. Specifically, the user management part 340 manages history data such as identification information of provided advertising videos or images, user IDs (identification) for identifying each terminal 140 to which the advertising image was downloaded, and downloading dates, for each of the servers 110 and 120 that are respectively operated by the client companies of the advertisement. The user management part 340 also stores data such as IDs of downloaded videos and images, downloading dates, and expiration dates for advertising videos and images by associating the respective types of data to each other, for each of the terminals 140A and 140B to which the advertising videos and images were downloaded.

The billing management part 360 refers to the data in the user database 350 that is managed by the user management part 340, and calculates the amount to be charged to a client of advertisement. After calculating the charge amount, the billing management part 360 has the charge amount associated with a company account that is managed by the user management part 340.

### Configuration of Computer System

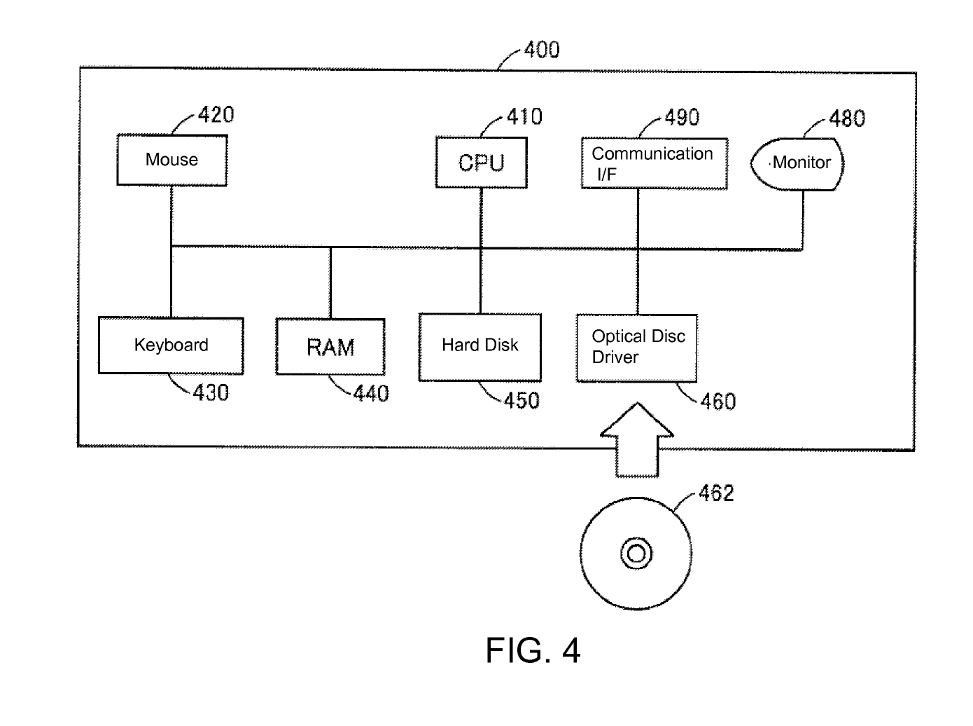

A computer system 400 that realizes the server 130 of the present embodiment will be explained with reference to FIG. 4. FIG. 4 is a block diagram showing a hardware configuration of the computer system 400.

The computer system 400 includes, as primary components thereof, a CPU (central processing unit) 410 that executes a program; a mouse 420 and a keyboard 430 that receive instructions from a user of the computer system 400; a RAM (random access memory) 440 that is a volatile memory for data that is generated by the CPU 410 as a result of executing the program, or data inputted through the mouse 420 or the keyboard 430; a hard disk 450 that is a non-volatile memory for data; an optical disc driver 460; a monitor 480; and a communication I/F (interface) 490. The respective components are connected to each other via data bus. A CD-ROM (compact disc read only memory) 462 or other optical discs can be loaded into the optical disc driver 460.

Each process in the computer system 400 is realized by hardware and software that is executed by the CPU 410. Such software may be stored in the hard disk 450 in advance, or such software may be stored in the CD-ROM 462 or other data recording media, and may be distributed as a program product. Alternatively, the software may be provided, by a data provider that is connected to the internet, as a program product that can be downloaded. Such software is read out from the data recording medium by the optical disc driver 460 or other reading devices, or is downloaded through the communication I/F 490, and thereafter, is temporarily stored in the hard disk 450. The software is read out from the hard disk 450 by the CPU 410, and is stored in the RAM 440 in the form of an executable program. The CPU 410 executes the program.

The respective components constituting the computer system 400 shown in FIG. 4 are commonly-used components. Therefore, it can be understood that the essential part of the present invention is the software that is stored in the RAM 440, the hard disk 450, the CD-ROM 462, or other data recording media, or the software that can be downloaded via a network. Because the hardware operation of the computer system 400 is known, the detailed explanation thereof is omitted.

The recording media are not limited to a CD-ROM, an FD (flexible disk), and a hard disk 450, and may be a medium that can store a program in a fixed manner such as a magnetic tape, a cassette tape, optical discs (MO (magnetic optical disc, MD (mini disc), DVD (digital versatile disc)), an IC (integrated circuit) card (including a memory card), an optical card, a mask ROM, an EPROM (electronically programmable read only memory), an EEPROM (electronically erasable programmable read only memory), a flash ROM, and other semiconductor memories.

The program in the present specification includes not only a program that can be directly executed by the CPU 410, but also a program in a source program format, a compressed program, an encrypted program, and the like.

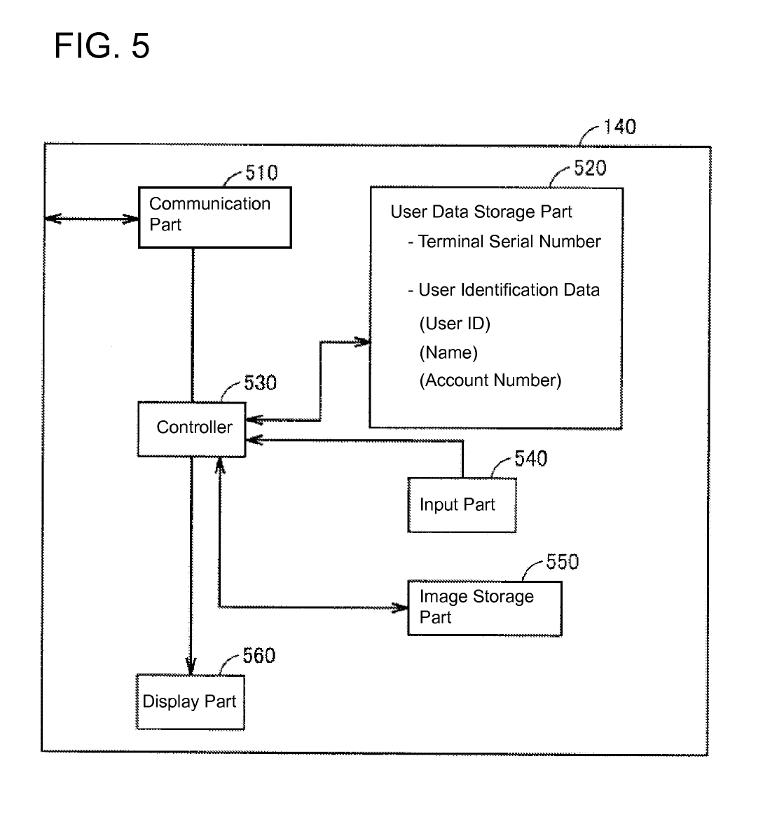

With reference to FIG. 5, a configuration of the terminal 140 of the present embodiment will be explained. FIG. 5 is a block diagram showing a configuration of functions realized by the terminal 140. The terminal 140 includes a communication part 510, a user data storage part 520, a controller 530, an input part 540, an image storage part 550, and a display part 560.

In one aspect, the communication part 510 can communicate with the servers 110, 120, and 130, respectively, via the internet 150. In another aspect, the communication part 510 of the terminal 140A may be configured to be able to communicate with a communication part 510 of another terminal 140B. The communication conducted through the communication part 510 may be wire communication or wireless communication.

The user data storage part 520 stores a serial number of the terminal 140 and user ID data of the terminal 140, for example. The user ID data includes a user ID, a name, and an account number, for example, but is not limited thereto.

The controller 530 refers to the data stored in the user data storage part 520, and controls operations of the terminal 140, based on inputs provided through the input part 540. In one aspect, the controller 530 communicates with the servers 110, 120, and 130 via the communication part 510. In another aspect, the controller 530 receives advertising image data from the server 130 via the communication part 510, and stores the data in the image storage part 550.

In another aspect, when the controller 530 detects a deletion of the image that has been stored in the terminal 140, the controller 530 notifies the server 130 of the deletion. The server 130 recalculates the advertising fee to be paid to the terminal 140, based on the period during which the image was stored in the terminal 140 (or in other words, the period during which the advertisement was displayed). If the return is shorter than the planned period, the server 130 reduces the advertising fee.

In another aspect, the terminal 140 may be provided with an acceleration sensor. In this case, the controller 530 can detect a movement of the terminal 140, and if small vibration is detected, for example, the controller 530 determines that the terminal 140 is in an environment in which the terminal 140 is viewed by others (on the train, for example). The controller 530 then controls each part such that an advertising image is displayed. With this configuration, an advertisement is not displayed if there is no one around, and therefore, it is possible to reduce power consumption of the terminal 140.

In another aspect, the controller 530 detects the position of the terminal 140. If the position of the terminal 140 is detected on a train route, for example, the controller 530 causes advertising images to be displayed in a plurality of screens. With this configuration, an advertisement is not displayed if there is no one around, and therefore, it is possible to reduce power consumption of the terminal 140.

In yet another aspect, the terminal 140 may be configured so as to display an advertisement of a company that is present near the detected position. For example, when the positional information is detected, the terminal 140 sends the positional information to the server 130. Based on the positional information, the server 130 conducts a search for a company that is within a prescribed range and that is registered as a client company of an advertisement. If such a company is registered, the server 130 sends a message to the terminal 140 for prompting the user to allow for the display of the advertisement. When the user of the terminal 140 conducts an operation to allow such an advertisement to be displayed, the server 130 sends advertising image data for the company. With this configuration, an appropriate image display can be conducted based on the position of the terminal 140, and it is possible to improve the advertising effect.

The input part 540 accepts an input of instructions for the terminal 140. In one aspect, the input part 540 is configured as a switch, a touch panel, an infrared light-receiver, or other user input interfaces.

The image storage part 550 stores image data. In one aspect, the image data is received via the internet 150. If a removable recording medium can be loaded to the terminal 40, image data stored in the recording medium may be stored in the image storage part 550. In one aspect, the image storage part 550 is realized by a flash memory or other media that are non-volatile data storages.

The display part 560 is configured such that a plurality of screens are displayed in different directions. The display part 560 is controlled by the control part 530 to display an advertising video or image on one screen, based on the data stored in the image storage part 550. The terminal 140 can display advertising images for a plurality of companies, and in such a case, an advertising image for one company is displayed in one screen. In one aspect, the display part 560 repeatedly displays advertising videos or images. In another aspect, the display part 560 may be configured to display videos or images in the screen 220 and the screen 230 only when an image is displayed in the screen 210 that is used by the user of the terminal 140.

### Hardware Configuration

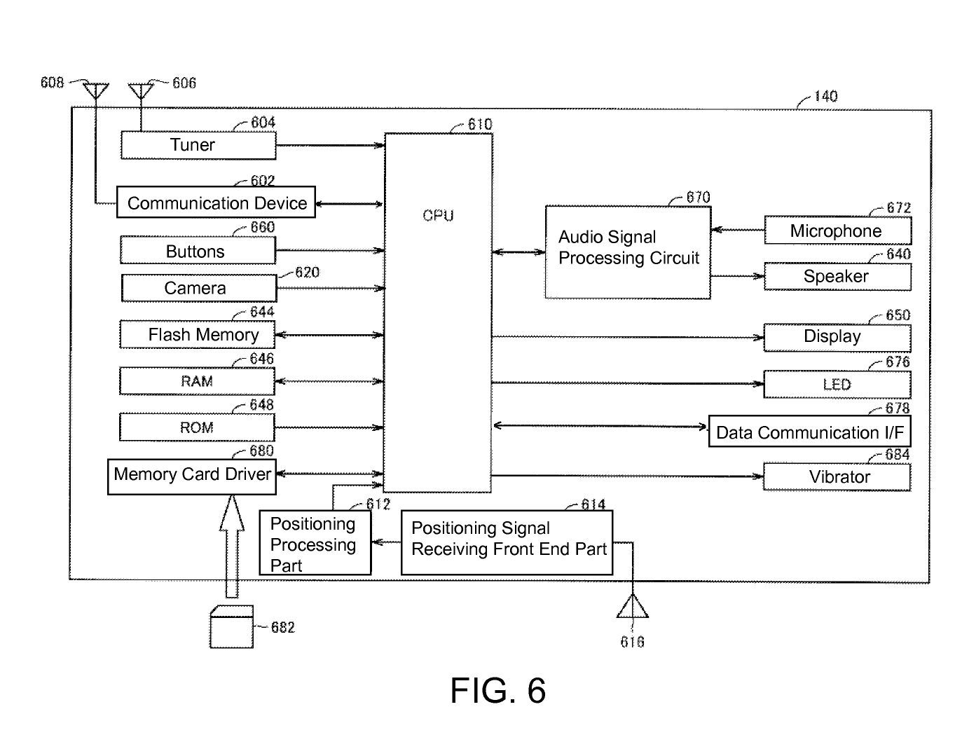

With reference to FIG. 6, a hardware configuration of the terminal 140 of the present embodiment will be explained. FIG. 6 is a block diagram showing a hardware configuration of the terminal 140. In addition to the configuration shown in FIG. 1, the terminal 140 includes a communication device 602, a tuner 604, antennas 606 and 608, a CPU (central processing unit) 610, a positioning processing part 612, a positioning signal receiving front end part 614, a GPS (global positioning system) antenna 616, a camera 620, a flash memory 644, a RAM (random access memory) 646, a ROM (read only memory) 648, an audio signal processing circuit 670, an LED (light emitting diode) 676, a memory card driver 680, a data communication I/F (interface) 678, and a vibrator 684. A memory card 682 can be loaded into the memory card driver 680.

The antenna 606 receives 1seg broadcast waves. The tuner 604 selects a channel according to instructions from the CPU 610, and sends image signals and audio signals to the CPU 610.

The signal received by the antenna 608 undergoes front-end processing conducted by the communication device 602, and the processed signal is sent to the CPU 610. The CPU 610 conducts processes to control operations of the terminal 140, in accordance with instructions given to the terminal 140. The CPU 610 conducts a prescribed process based on the signal sent from the communication device 602, and sends the processed signal to the audio signal processing circuit 670. The audio signal processing circuit 670 conducts a prescribed process on the signal, and the processed signal is sent to a speaker 640. The speaker 640 outputs sounds based on the signal.

A microphone 672 receives sounds outputted to the terminal 140, and sends a signal corresponding to the outputted sounds to the audio signal processing circuit 670. The audio signal processing circuit 670 conducts a prescribed process for a telephone call, based on the signal, and the processed signal is sent to the CPU 610. The CPU 610 converts the signal to transmission data, and the converted data is sent to the communication device 602. The communication device 602 generates a transmission signal based on the data, and the signal is sent to the antenna 608.

The flash memory 644 stores data sent from the CPU 610. The CPU 610 reads out the data stored in the flash memory 644, and conducts a prescribed process using the data.

The RAM 646 temporarily stores data generated by the CPU 610 based on the operation that the user conducted through buttons 660. The ROM 648 stores therein a program or data for having the terminal 140 perform prescribed operations. The CPU 610 reads out the program or data from the ROM 648, and controls the operations of the terminal 140.

The memory card driver 680 reads out data stored in the memory card 682, and sends the data to the CPU 610. The memory card driver 680 also writes into a free space in the memory card 682 the data outputted from the CPU 610.

The audio signal processing circuit 670 conducts the above-mentioned signal processing for a telephone call. In the example shown in FIG. 6, the CPU 610 and the audio signal processing circuit 670 are shown as separate components, but in another aspect, the CPU 610 and the audio signal processing circuit 670 may be integrally configured.

A display 650 is a touch panel display, but there is no special limitation on the mechanism of the touch panel. The display 650 is at least a display that can display two or more screens, and is attained by a liquid crystal display device that can form a parallax barrier, for example. The display 650 displays images defined by data that is obtained from the CPU 610. For example, the display 650 displays still images, videos, or attributes of music files (such as names, artists, and play times of the files), which are stored in the flash memory 644.

The LED 676 emits light in a prescribed manner based on a signal from the CPU 610. The data communication I/F 678 is where a data communication cable can be plugged in. The data communication I/F 678 sends to the cable a signal outputted from the CPU 610. Also, the data communication I/F 678 sends to the CPU 610 data received through the cable.

The vibrator 684 oscillates with a vibration pattern set by the user, based on a signal outputted from the CPU 610.

The GPS antenna 616 receives a signal sent from the GPS satellite, and sends the received signal to the positioning signal receiving front end part 614. The positioning signal receiving front end part 614 conducts pattern matching based on respective signals received from at least three (preferably four or more) GSP satellites, and when the code pattern included in each signal matches the code pattern held by the terminal 140, the positioning signal receiving front end part 614 sends the signal to the positioning processing part 612. In one aspect, the terminal 140 does not need to have the positioning function.

The positioning processing part 612 conducts a positioning process using the signal, and calculates the position of the terminal 140 that received the signal. The CPU 610 displays the calculation result on the display 650.

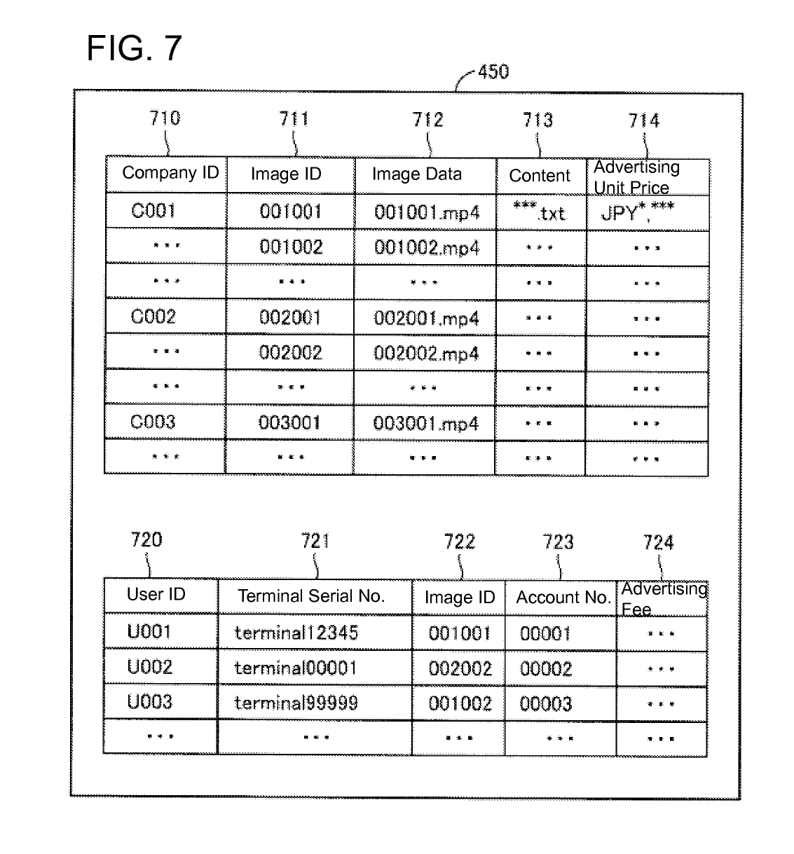

With reference to FIG. 7, the data structure of the server 130 will be explained. FIG. 7 schematically shows an example of data storage in the hard disk 450 of the server 130. The hard disk 450 stores therein, as a company data, company IDs 710, image IDs 711, image data 712, contents 713 of the image data, and advertising unit prices 714 as company data, for example. Each data is associated with the company IDs 710 and the image IDs 711, for example.

The company ID 710 identifies a client company of the advertisement. The image ID 711 identifies an advertising image for the company. As shown in the examples of 001001, 001002 for the image ID 711, it is possible for one company to register a plurality of images as advertising images.

The content 713 includes a string that represents the content of each of the advertising images. This way, the administrator of the server 130 is able to know the content of the image. The advertising unit price 714 is set as a fee to place an advertisement for the company. The advertising unit price 714 is constituted of a fixed portion as a base rate, and a variable portion as a usage-based rate, for example. The usage-based rate is used as an advertising fee per download by the terminal 140, for example.

In addition, the hard disk 450 stores therein user IDs 720, terminal serial numbers 721, image IDs 722, account numbers 723, and advertising fees 724 as user data. The user ID 720 is provided to identify a user of each terminal 140 such as the terminal 140A and the terminal 140B. The terminal serial number 721 is a specific number designated to each terminal, and is sent from each terminal 140. The user ID 720 is automatically created when the server 130 newly registers a user of a terminal 140. The user ID 720 is constituted of a user name that is arbitrarily assigned to the user, the address of the user, and the like.

The image ID 722 is used to identify the image downloaded to the terminal of the user from the server 130. In one aspect, the terminal 140 can display two or more advertising images at the same time. Therefore, the record that uses the user ID 720 as a key is created for each image ID 722.

The account number 723 is a number provided by the user of the terminal 140, and is used as an account to which a payment for the advertising fee 724 is made. The advertising fee 724 is paid by the client company (refer to the company ID 710) of the advertisement, which has provided a video or image identified by the image ID 722. The advertising fee 724 corresponds to the usage-based portion of the advertising unit price 714 mentioned above.

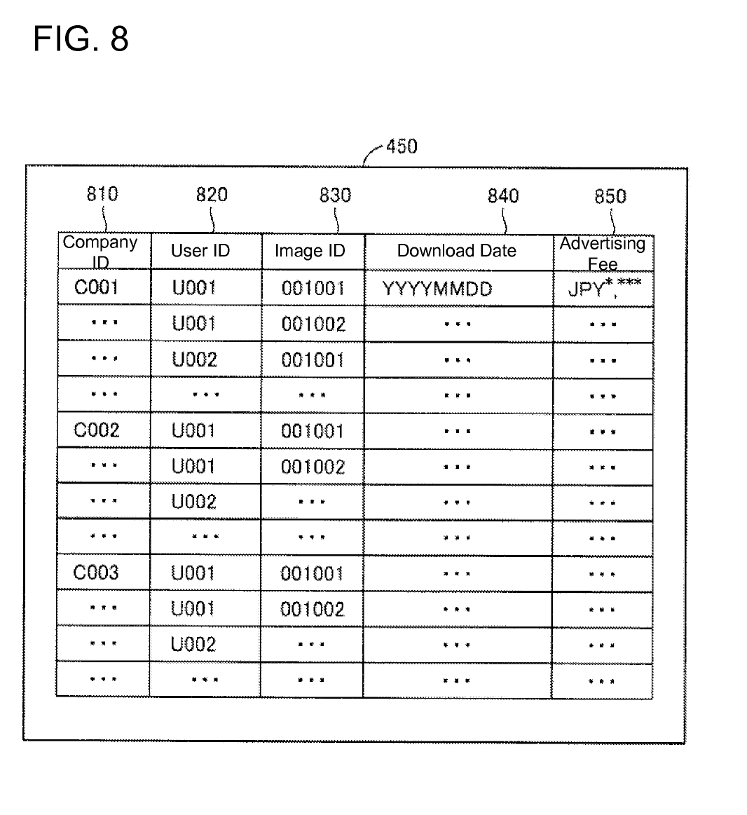

With reference to FIG. 8, the data structure of the server 130 will be further explained. FIG. 8 is a diagram showing an image download history of each terminal.

The hard disk 450 stores therein company IDs 810, user IDs 820, image IDs 830, downloading dates 840, and advertising fees 850. The CPU 410 of the server 130 keeps storing in the hard disk 450 a data record, in which these items are associated with each other, as an advertising history. The advertising fees 850 can be calculated from the history and master data, and is therefore not necessarily included in the history.

### Control Configuration of Terminal 140

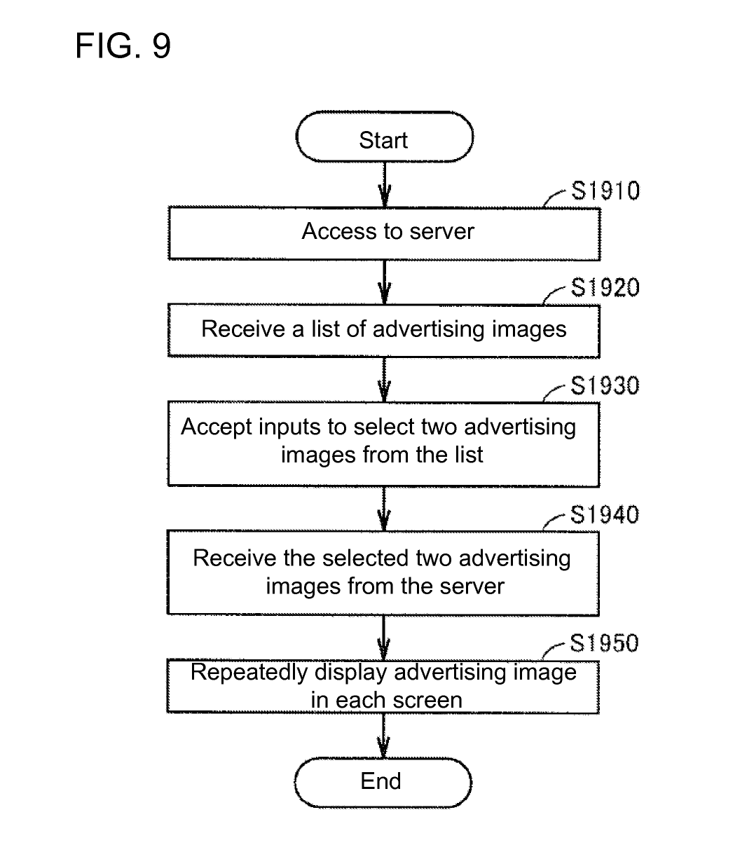

With reference to FIG. 9, a control configuration of the terminal 140 of the present embodiment will be explained. FIG. 9 is a flowchart that shows a part of a series of processes executed by the CPU 610 of the terminal 140.

In step S1910, the CPU 610 accesses the server 130 based on the operation conducted through the buttons 660. The user of the terminal 140 accesses a website to receive an advertisement, while viewing the display 650.

In step S1920, the CPU 610 receives a list of advertising images for companies from the server 130. The display 650 of the terminal 140 displays the list in such a manner that the user can make a selection.

In step S1930, the CPU 610 receives inputs provided to select two images (that is, two advertisements) from the list. For example, the user selects the images or the companies displayed in association with the images. When the terminal 140 can display four screens, the user can select as many as four images. The terminal 140 sends to the server 130 data that specifies the selected images, data that identifies the terminal 140, and the user ID. The server 130 has the user ID and the image ID associated with each other, and updates the data in the hard disk 450. The server 130 sends two images that have been selected by the user to the terminal 140.

In step S1940, the CPU 610 receives from the server 130 two advertising images that have been selected.

In step S1950, the CPU 610 repeatedly displays the images in the respective screens 220 and 230. The display intervals are set to 15 seconds to 30 seconds, or the like, for example, but the display time is not limited thereto. The image to be displayed in each screen is assigned to one of the screen 220 and the screen 230 in the order received by the terminal 140, for example.

### Control Configuration of Server 130

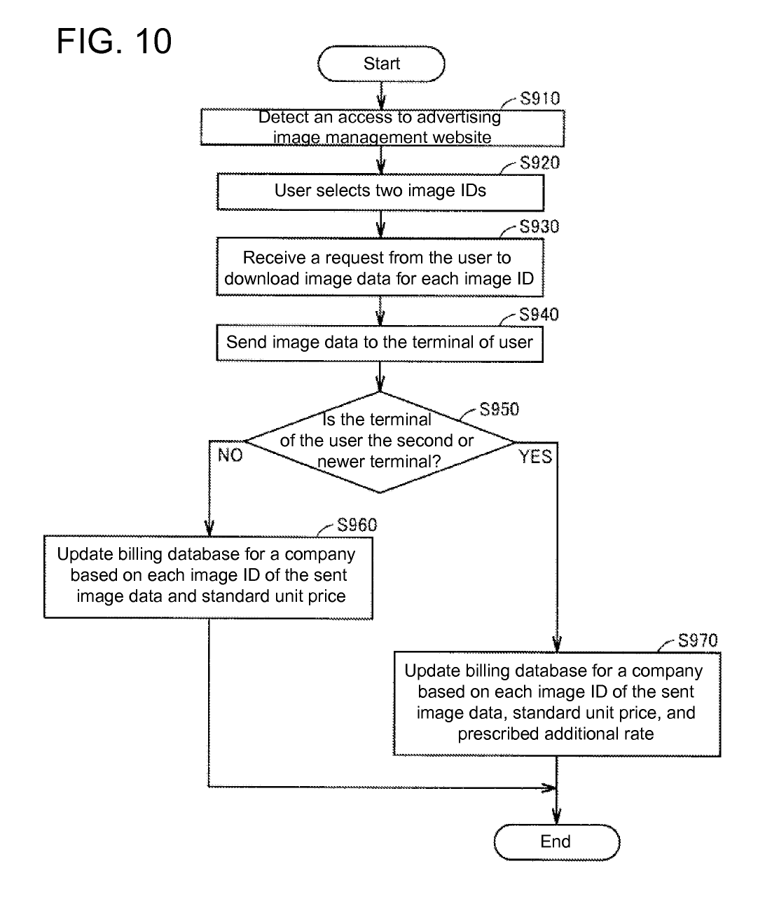

With reference to FIGS. 10 to 12, the control configuration of the server 130 of the present embodiment will be explained. FIG. 10 is a flowchart that shows a part of a series of processes executed by the CPU 410 of the server 130.

In step S910, the CPU 410 detects an access of the terminal 140 to an advertising image management website.

In step S920, the CPU 410 detects that the user of the terminal 140 has selected two image IDs, based on the data provided by the terminal 140 (user ID, terminal serial number, image ID, and the like).

In step S930, the CPU 410 detects that a request for downloading image data for each image ID has been received from the user of the terminal 140.

In step S940, in response to the request for the download, the CPU 410 sends image data stored in the hard disk 450 to the terminal 140 of the user, based on the image IDs received from the terminal 140.

In step S950, the CPU 410 determines whether the terminal 140 of the user is the second or newer terminal of the same user or not. The second or newer terminal means that there are two or more terminals registered for the same user. For example, when the user has changed the terminal from an old model to a new model, the new model terminal is the second or newer terminal. This is determined by referring to the history of the serial numbers. If the terminal 140A is the second or newer terminal (YES in step S950), the CPU 410 proceeds to step S970. If not (NO in step S950), the CPU 410 proceeds to step S960.

In step S960, the CPU 410 updates the download history (FIG. 8), which is the billing database for the companies, based on each image ID for the image data sent to the terminal 140 and the standard unit price. In this case, the standard rate is applied to the advertising fee charged to the company as a result of displaying an advertisement in the terminal 140.

In step S970, the CPU 410 updates the downloading history (FIG. 8), which is the billing database for the companies, based on each image ID for the image data sent to the terminal 140, the standard unit price, a predetermined additional rate, and the like. In this case, the higher rate than the standard rate is applied to the advertising fee charged to the company as a result of displaying an advertisement in the terminal 140.

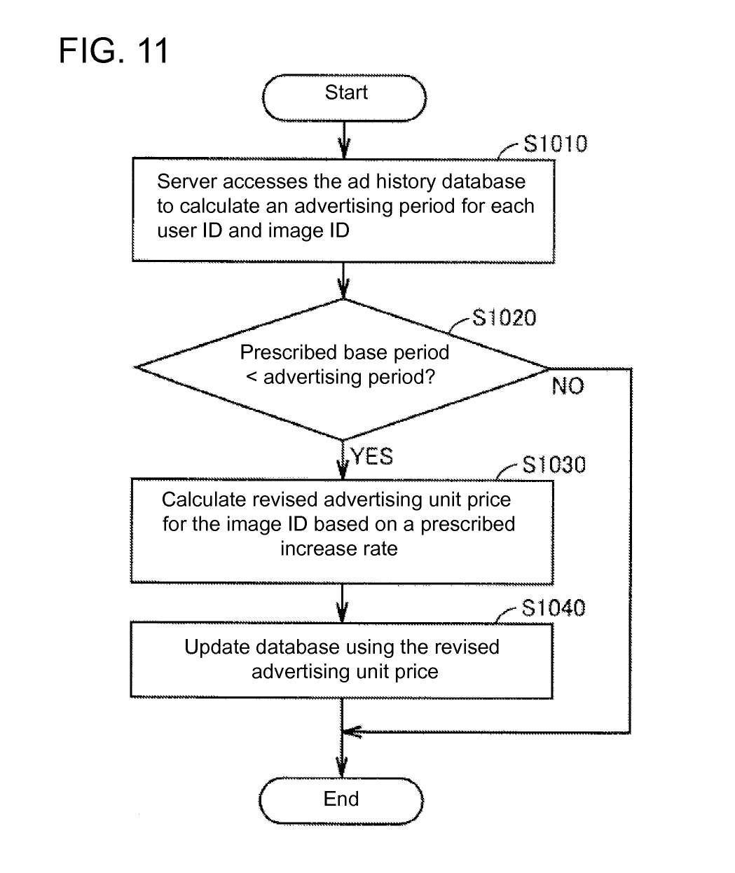

FIG. 11 is a flowchart that shows a part of a series of processes executed by the CPU 410 to update the advertising fee in accordance with the advertising period.

In step S1010, the CPU 410 accesses the database (FIG. 8), and based on the user ID 820 and the image ID 830, calculates a period during which the advertisement has been displayed using the image. For example, this period is calculated based on a difference between the downloading date 840 and the time indicated by an internal clock of the CPU 410.

In step S1020, the CPU 410 compares the base period that is predetermined as a base period for advertisement with the length of the period in which the advertisement was actually displayed (advertising period). If the advertising period is longer than the predetermined base period (YES in step S1020), the CPU 410 proceeds to step S1030. If not (NO in step S1020), the CPU 410 ends the control process.

In step S1030, the CPU 410 calculates a revised advertising unit price of the image ID, based on a predetermined increase rate. In step S1040, the CPU 410 updates the advertising unit price 714 in the database by using the revised advertising unit price. As a result, the unit price for the advertisement that is displayed for a long period of time is increased.

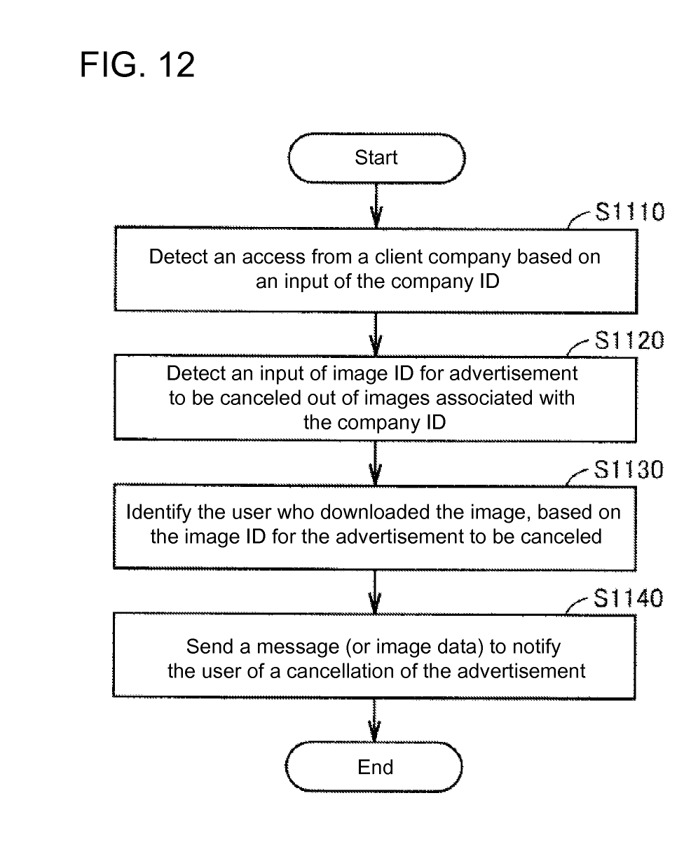

FIG. 12 is a flowchart showing processes executed by the CPU 410 for sending a notification from the server 130 to the terminal 140 when the company cancels the advertisement.

In step S1110, the CPU 410 detects an access from a client company of the advertisement, based on the company ID sent from the server 110 or 120. In step S1120, the CPU 410 detects an input of the image ID of the advertisement that is to be cancelled, out of images that are associated with the company ID.

In step S1130, the CPU 410 refers to the database based on the image ID of the advertisement that is to be cancelled, and identifies a user who has downloaded the image.

In step S1140, the CPU 410 sends to the terminal 140 used by the user a message (or image data) that the advertisement is to be cancelled. As a result, the terminal 140 recognizes that it is no longer necessary to display the image that has been displayed for advertisement. In one aspect, the terminal 140 stops displaying the image.

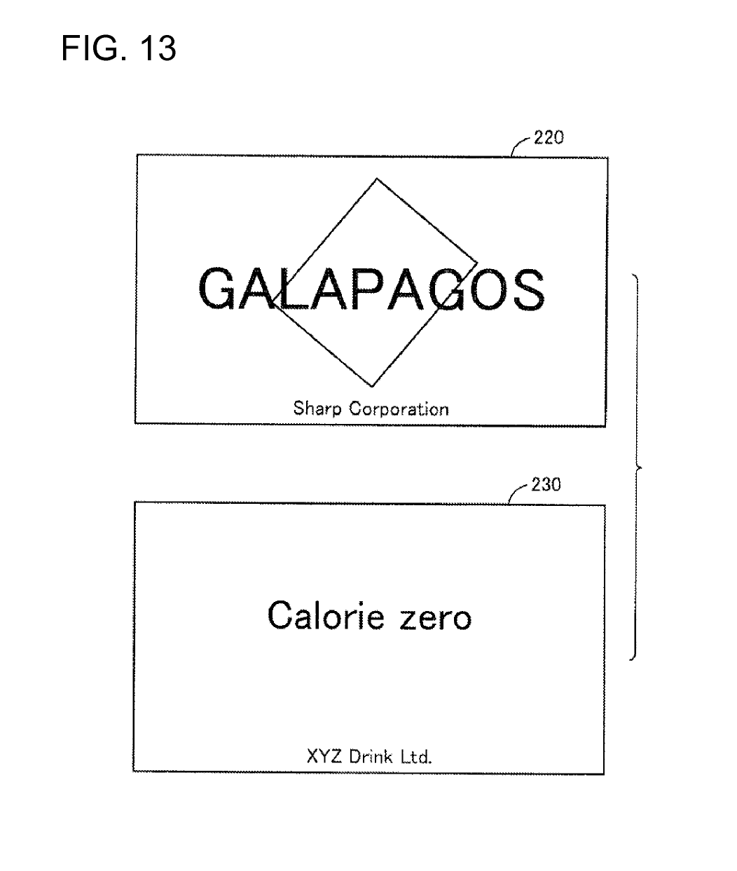

With reference to FIG. 13, a screen display state of the terminal 140 of the present embodiment will be explained. FIG. 13 is a diagram showing images displayed on screens 220 and 230 that are viewed by people other than the user of the terminal 140, out of three screens that can be displayed by the terminal 140. In one aspect, for example, the screen 220 displays an advertising image for “Galapagos” of “Sharp Corporation.” On the other hand, the screen 230 displays an advertising image (Calorie Zero) of another company (XYZ Drink Ltd.). The terminal 140 repeatedly displays the respective images in the respective screens. As a result, while the user of the terminal 140 is viewing e-book, webpages, emails, or the like displayed on the screen 210, for example, other users can view the advertising images displayed on the screens 220 and 230 of the terminal 140. By one terminal 140 displaying a plurality of images, it is possible to display advertisements for others, while the owner of the terminal 140 is using the terminal 140 for personal use. The user is paid the advertising fee for displaying the advertising images, and the user can allocate the amount to pay for the communication cost, for example. Because the companies can get permissions from the user for advertisement, the advertising effect can be improved for the companies.

### Embodiment 2

Below, Embodiment 2 of the present invention will be explained in detail. The system of the present embodiment differs from the above embodiment in that games are downloaded.

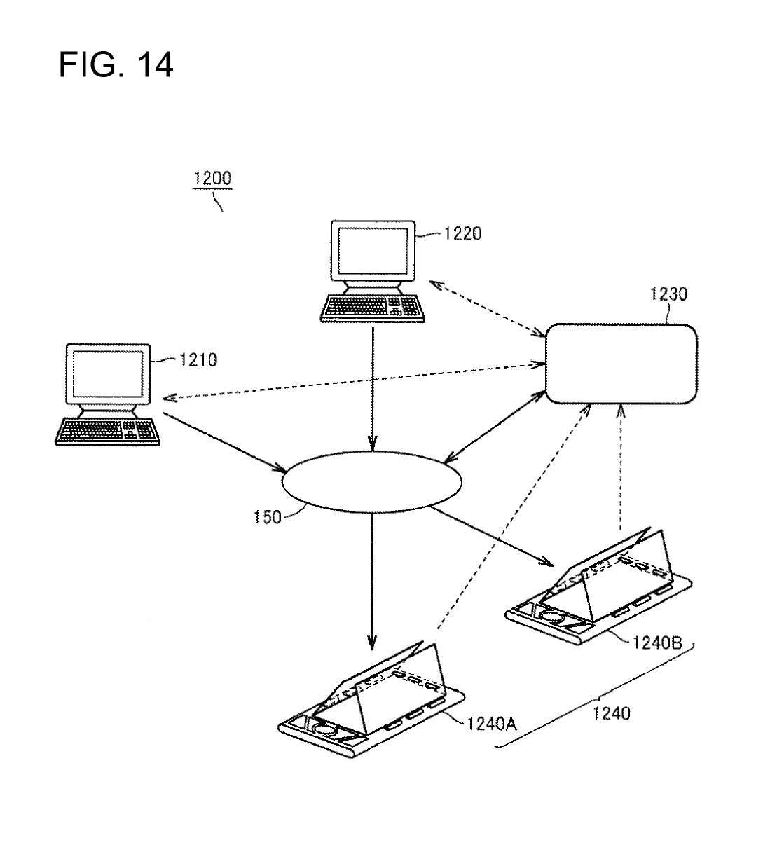

With reference to FIG. 14, a configuration of a system 1200 of the present embodiment will be explained. FIG. 14 is a diagram showing a configuration of the system 1200. The system 1200 has a server 1230 and terminals 1240. The server 1230 and the terminals 1240 are respectively connected to the internet 150. Servers 1210 and 1220 are also connected to the internet 150, respectively. The servers 1210 and 1220 are respectively managed by creators of games. The creators of games may be companies or individuals.

The servers 1210, 1220, and 1230 of the present embodiment have a configuration similar to the hardware configuration of the server 130. The terminal 1240 has a configuration similar to the hardware configuration of the terminal 140. Therefore, the descriptions of the hardware configurations are not repeated.

In one aspect, a first game creator that manages the server 1210 and a second game creator that manages the server 1220 respectively register games for three screens or games for four screens in the server 1230. Specifically, the server 1210 or the server 1220 accesses the server 1230 managed by the administrator of a game registration management website, and accepts registrations of downloadable games through the internet 150. Upon registration of the games, each creator pays a registration fee that is predetermined by the server 1230.

The user of the terminal 1240A or 1240B (may be collectively referred to as a terminal 1240 below) accesses the server 1230, and downloads a game for three screens or four screens. Examples of the game include card games, the Game of Life, and Monopoly, but not limited thereto. The user of the terminal 1240 pays predetermined fees to the server 1230 online upon downloading the game. When receiving the payment, the server 1230 pays the downloading fee to the server 1210 or the server 1220, i.e., the creator of the game.

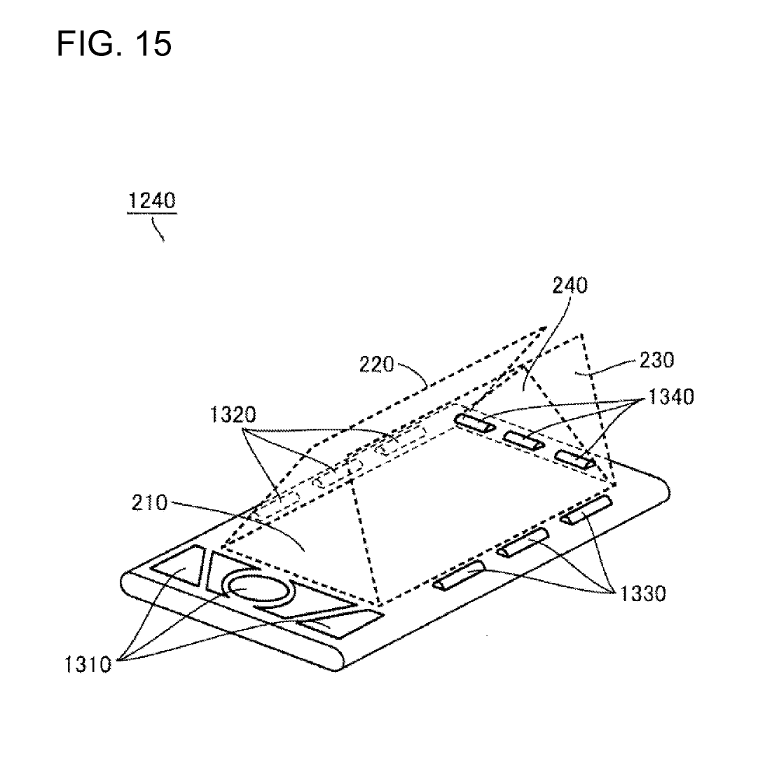

With reference to FIG. 15, a screen display state of the terminal 1240 of the present embodiment will be explained. FIG. 15 is a diagram showing a display status of screens by the terminal 1240 that can display four screens. In one aspect, the terminal 1240 displays a screen 210, a screen 220, a screen 230, and a screen 240. The screens 210 to 230 have the same display configuration as those in the terminal 140 of Embodiment 1. In addition, the terminal 1240 can display the screen 240 in a direction opposite to the screen 210.

The terminal 1240 includes groups of buttons 1310 to 1330 that accept operations of users who view the respective screens. The group of buttons 1310 is used by the user who is viewing the screen 210. The group of buttons 1320 is used by the user who is viewing the screen 220. The group of buttons 1330 is used by the user who is viewing the screen 230. The group of buttons 1340 is used by the user who is viewing the screen 240.

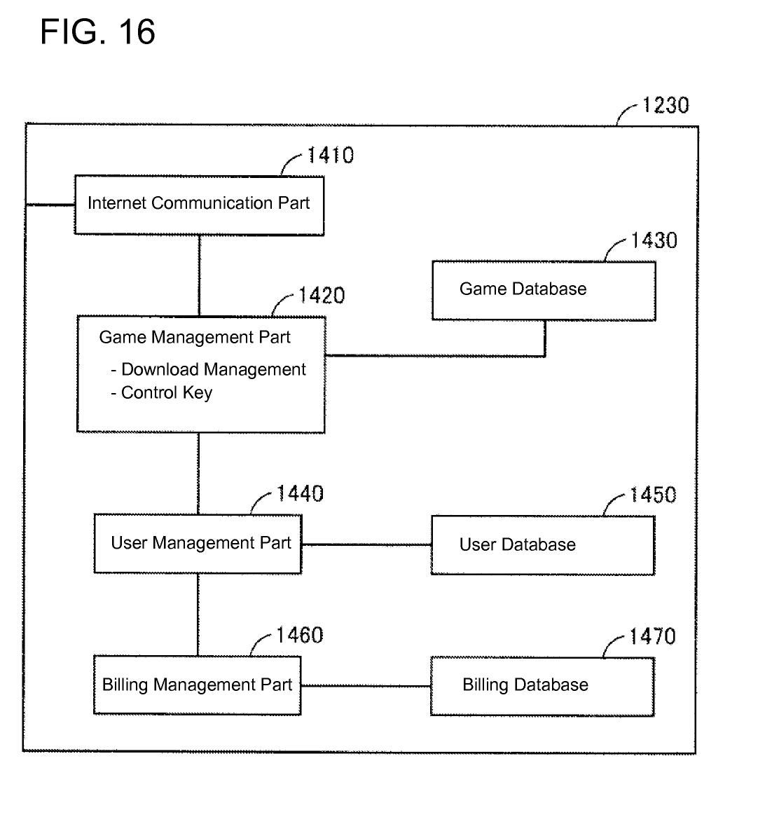

With reference to FIG. 16, a configuration of the server 1230 of the present embodiment will be explained. FIG. 16 is a block diagram showing a configuration of functions realized by the server 1230. The server 1230 includes an internet communication part 1410, a game management part 1420, game database 1430, a user management part 1440, user database 1450, a billing management part 1460, and billing database 1470.

The internet communication part 1410 communicates with other servers 1210 and 1220, or the terminals 1240A and 1240B through the internet 150.

The game management part 1420 manages games that are uploaded by game creators, and manages games that are downloaded to the terminal 1240 by the user. Specifically, the game management part 1420 stores in the game database 1430 software of the games sent from the game creators via the internet communication part 1410. The game management part 1420 also creates a control key for preventing an unauthorized use of the game in which the game is not properly downloaded, and associates the control key with the software of the game. When the control key differs from a control key that is sent from the correct terminal 1240, the game management part 1420 does not send a key that is necessary to start the game.

The user management part 1440 manages the terminal 140 of the user to which the game is to be downloaded, based on the data received via the internet communication part 1410. The user management part 1440 stores in the user database 1450 information of the user who downloaded the game, and updates the database as necessary.

The billing management part 1460 calculates the registration fee that is to be charged to developers of games. The registration fee is paid by the developers to the server 1230. The billing management part 1460 also calculates billing data for the user who has downloaded a game. The billing management part 1460 stores in the billing database 1470 the calculated data as necessary.

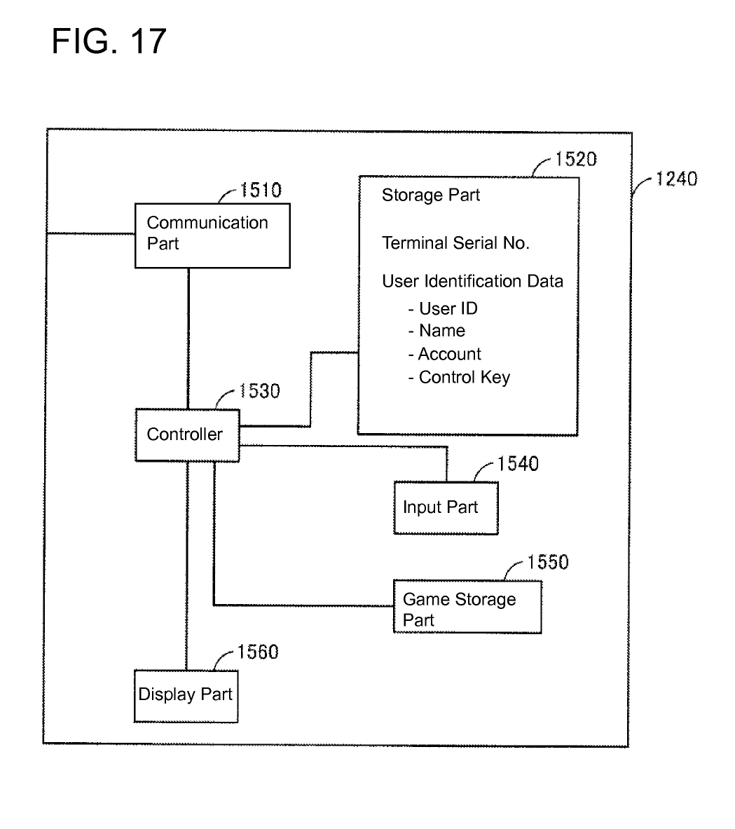

With reference to FIG. 17, a configuration of the server 1240 of the present embodiment will be explained. FIG. 17 is a block diagram showing a configuration of functions realized by the terminal 1240. The terminal 1240 includes a communication part 1510, a storage part 1520, a controller 1530, an input part 1540, a game storage part 1550, and a display part 1560.

The communication part 1510 communicates with the servers 1210, 1220, and 1230 via the internet 150.

The storage part 1520 stores therein a serial number of the terminal 1240, and user identification data. The user identification data includes a user ID, a name, an account number, and a control key, for example. The user ID is allocated by the server 1230, or is selected by the user of the terminal 1240. The name and account number are provided by the user. In one aspect, the account number is used for allowing the user of the terminal 1240 to use the communication service. The control key is allocated by the server 1230 to a user when the user registers in the server 1230, and is sent to the terminal 1240.

The controller 1530 controls operations of the terminal 1240, based on instructions provided through the input part 1540. Specifically, the controller 1530 communicates with the server 1230 via the communication part 1510. When the user of the terminal 1240 selects a game to be downloaded, the controller 1530 sends a download request to the server 1230. In another aspect, in accordance with an instruction to start a game, which is provided to the input part 1540, the controller 1530 reads out the game from the game storage part 1550, and requests a key that is necessary to start the game be sent from the server 1230. Because the server 1230 needs to authorize the terminal 1240, the controller 1530 sends the serial number and the control key as a user ID to the server 1230, for example.

The game storage part 1550 stores therein games that have been downloaded from the server 1230. In one aspect, the game storage part 1550 is configured as a storage medium that is provided in a fixed manner in the terminal 1240 such as the hard disk 450, for example. In another aspect, the downloaded games may be stored in a removable recording medium. In this case, in order to prevent an unauthorized use by another terminal that is not registered in the server 1230, data for protecting the game data may be additionally stored in the recording medium.

The display part 1560 displays screens of the game that is read out from the game storage part 1550 in accordance with the control of the controller 1530. If the terminal 1240 can display three or more screens, the display part 1560 displays the respective screens.

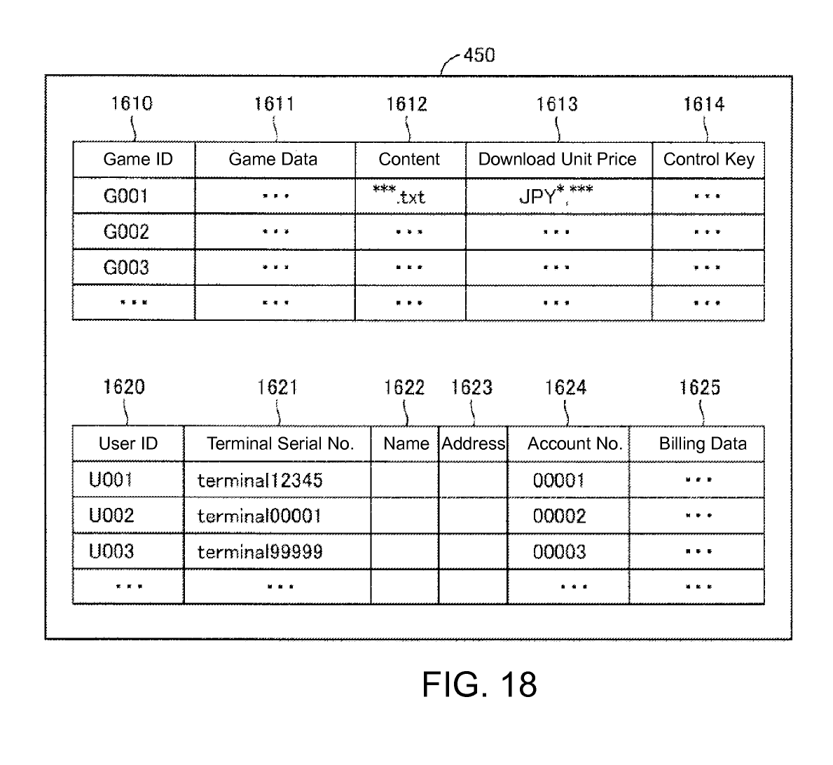

With reference to FIG. 18, a data structure of the server 1230 of the present embodiment will be explained. FIG. 18 schematically shows an example of data storage in the hard disk 450. The hard disk 450 stores therein game IDs 1610, game data 1611, contents 1612 of the game data, download unit prices 1613, and control keys 1614 as game database. Each data is associated with each other. The hard disk 450 also stores therein user IDs 1620, terminal serial numbers 1621, names 1622, addresses 1623, account numbers 1624, and billing data 1625 as user data. Each of these items is also associated with each other. The user ID 1620 is automatically provided every time a user accesses the server 1230. In another aspect, it is possible to use a configuration in which, when a user of the terminal 1240 inputs a user ID, the CPU 410 of the server 1230 checks if there is an existing user ID that is the same as the inputted user ID, and if there is not the same user ID, the inputted user ID is registered.

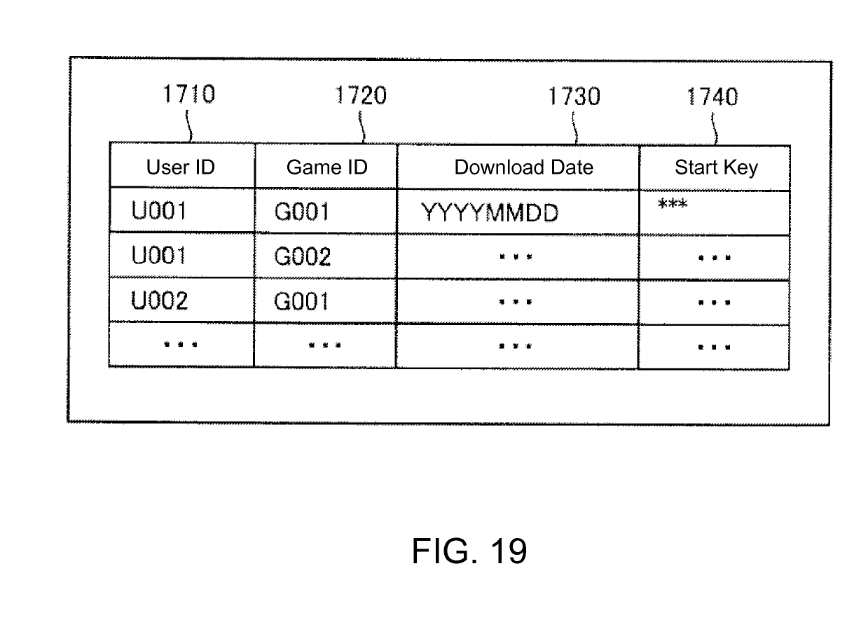

With reference to FIG. 19, the data structure of the server 1230 will be further explained. FIG. 19 is a diagram showing an example of history database for games downloaded by a user. The hard disk 450 stores therein user IDs 1710, game IDs 1720, downloading dates 1730, and start keys 1740. Each record in the advertising history database is updated every time each user downloads a game. The start key is provided to control whether or not permission for starting the game is to be given to the user who has downloaded the game. When the control key sent by the terminal 1240 and the control key stored in the server 1230 match, the server 1230 determines that the user of the terminal 1240 is a valid user, and the server 1230 sends the start key to the terminal 1240. The terminal 1240 applies the start key to the game data 1611, loads the game in an executable mode into the RAM 646, and starts the game.

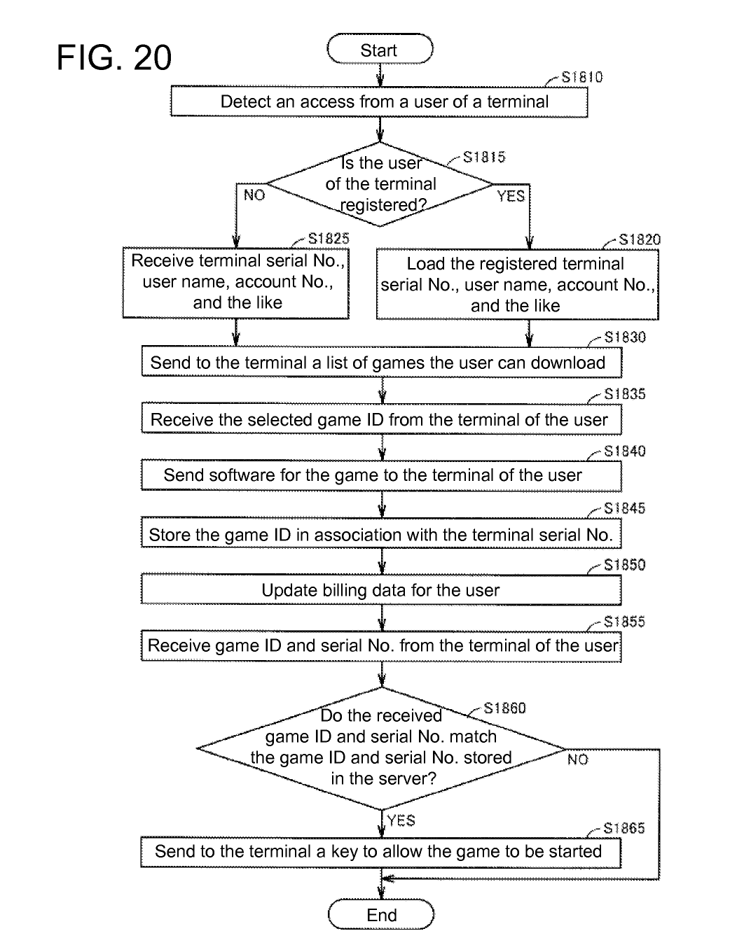

With reference to FIG. 20, a control configuration of the server 1230 of the present embodiment will be explained. FIG. 20 is a flowchart showing processes executed by the CPU 410 of a computer system that functions as the server 1230.

In step S1810, the CPU 410 detects an access from the user of the terminal 1240.

In step S1815, the CPU 410 refers to the user data (FIG. 18), and determines whether the user of the terminal 1240 has been registered or not. If the user who attempted the access has been registered (YES in step S1815), the CPU 410 proceeds to step S1820. If not (NO in step S1815), the CPU 410 proceeds to step S1825.

In step S1820, the CPU 410 loads onto the RAM 440 the terminal serial number, the user name, the account number, and the like, which have been already registered.

In step S1825, the CPU 410 accepts and stores a serial number of the terminal 1240, a user name, an account number, and the like into the hard disk 450, based on the data received from the terminal 1240 through the communication I/F 490

In step S1830, the CPU 410 sends a list of games that can be downloaded by the user to the terminal 1240. The display 650 of the terminal 1240 displays the list. The user of the terminal 1240 selects one game by operating the display 650 with a touch panel, or operating the buttons 660. The terminal 1240 sends the selected game ID to the server 1230.

In step S1835, the CPU 410 detects that the selected game ID has been received from the terminal 1240 of the user.

In step S1840, the CPU 410 sends the game software to the terminal 1240 of the user, based on the game ID received from the terminal 1240. The terminal 1240 detects a receipt of the software.

In step S1845, the CPU 410 stores the game ID in association with the user ID 1710 of the terminal 1240 (FIG. 19).

In step S1850, the CPU 410 updates the billing data for the user.

In step S1855, the CPU 410 receives the game ID and the serial number from the terminal 1240 of the user.

In step S1860, the CPU 410 determines whether the received game ID and serial number match the game ID and serial number that are stored in the server. If the game IDs and serial numbers match (YES in step S1860), the CPU 410 proceeds to step S1865. If not (NO in step S1860), the CPU 410 ends the process.

In step S1865, the CPU 410 sends a start key to allow the game to be started to the terminal 1240. The terminal 1240 applies the start key to the game software, and loads the executable data onto the RAM 646.

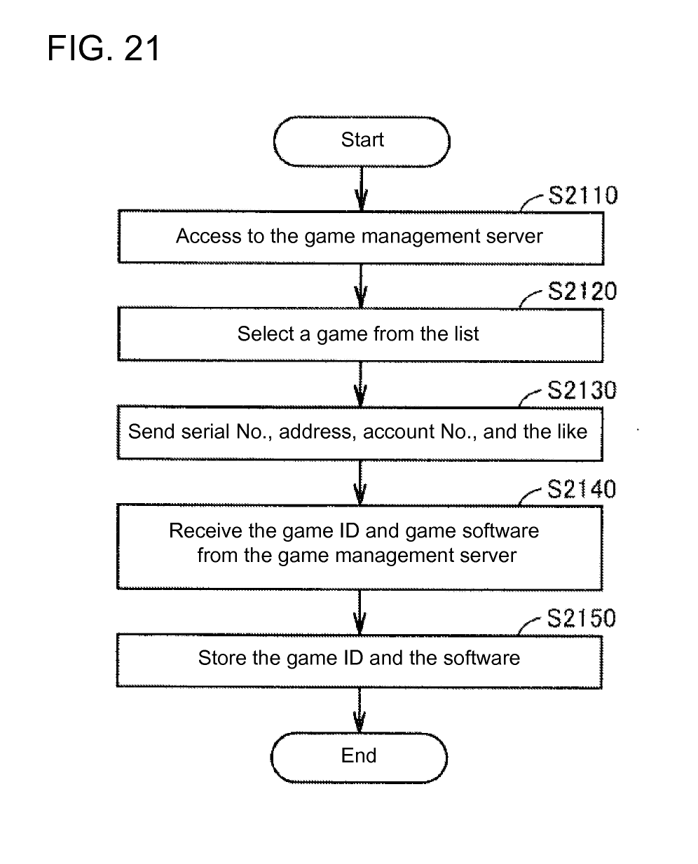

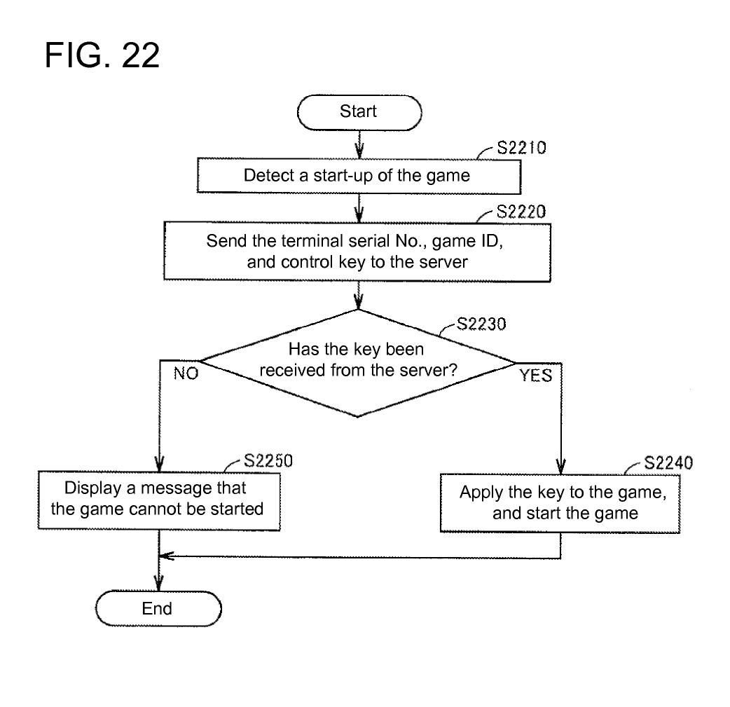

With reference to FIGS. 21 and 22, the control structure of the terminal 1240 of the present embodiment will be explained. FIGS. 21 and 22 are respectively flowcharts showing processes executed by the CPU 610 that realizes the functions of the terminal 1240.

In step S2110, the CPU 610 accesses the server 1230 that manages games through the communication device 602.

In step S2120, the CPU 610 detects that the user has selected a game from the list sent by the server 1230.

In step S2130, the CPU 610 sends serial number, name, address, account number, and the like of the terminal 1240 to the server 1230, in accordance with the operation conducted by the user using the buttons 660.

In step S2140, the CPU 610 receives the game ID and game software from the server 1230.

In step S2150, the CPU 610 stores the game ID and the software into the flash memory 644.

With reference to FIG. 22, in step S2210, the CPU 610 detects a request to start the downloaded game, based on an operation through the buttons 660.

In step S2220, the CPU 610 sends the serial number, the game ID, and the control key of the terminal 1240 to the server 1230.

In step S2230, the CPU 610 determines whether the start key, which is necessary to start the game, has been received from the server 1230 or not. When determining that the start key was received (YES in step S2230), the CPU 610 proceeds to step S2240. If not (NO in step S2230), the CPU 610 displays a message on the display 650 to notify the user of the terminal 1240 that the game cannot be started.

In step S2240, the CPU 610 applies the received key to the game software to start the game.

As described above, according to the system of the present embodiment, when a game selected by the user of the terminal 1240 is downloaded to the terminal 1240, the fee is charged to the user, and the fee is paid to the creator of the game. The administrator of the server 1230 receives the registration fee paid by the creators of games.

Because the terminal 1240 can display a plurality of screens, in addition to the user of the terminal 1240, a screen on each side can be viewed by another person, for example. In this way, a plurality of players can play the game using the terminal 1240 that is a portable terminal.

The present invention has been described in detail above, but the description above is illustrative only, and not limiting. It will be clearly understood that the scope of the invention shall be interpreted by the scope of the appended claims.

### INDUSTRIAL APPLICABILITY

The present invention can be applied to a terminal that can display a plurality of screen such as a dual view liquid crystal display device or a triple view liquid crystal display device and that has a communication function.

### DESCRIPTION OF REFERENCE CHARACTERS

100, 1200 system

110, 120, 130, 1210, 1220, 1230 server

140, 140A, 140B, 1240, 1240A, 1240B terminal

150 internet

210, 220, 230, 240 screen

1310, 1320, 1330 a group of buttons

1. A display device, comprising:
a display part configured to display screens in three or more directions;
an accessing part configured to access an image control apparatus that is provided externally by using data for identifying a user of the display device, the image control apparatus being connected to a communication network to send an image to the display device;
a selecting part configured to select at least one image provider;
a downloading part configured to download, from the image control apparatus, an advertising image for each image provider selected by the selecting part;
a storage part configured to store the advertising image that has been downloaded; and
a control part configured to control the display part such that the advertising image is displayed in either one or both of two directions out of the three or more directions.

2. The display device according to claim 1, further comprising a detecting part configured to detect a movement of the display device,
wherein, when a movement of the display device is detected, the control part causes the display part to display each said advertising image.

3. The display device according to claim 1, further comprising a deletion notification part configured to notify the image control apparatus of a deletion of the advertising image that has been downloaded.

4. The display device according to claim 1, further comprising:
a detecting part configured to detect a position of the display device,
wherein the image control apparatus conducts a search for an image provider that is present within a prescribed range from said position, and
wherein the control part causes the display part to display an advertising image for an image provider found in said search.

5. An image display system, comprising:
a display device; and
an image control apparatus that is connected to a communication network to send an image to the display device,
wherein the display device comprises:
a display part configured to display screens in three or more directions;
an accessing part configured to access said image control apparatus by using data for identifying a user of the display device;
a selecting part configured to select at least one image provider;
a downloading part configured to download, from the image control apparatus, an advertising image for each image provider selected by the selecting part;
a storage part configured to store the advertising image that has been downloaded; and
a control part configured to control the display part such that the advertising image is displayed in either one or both of two directions out of the three or more directions.

6. The image display system according to claim 5, further comprising a detecting part configured to detect a movement of the display device,
wherein, when a movement of the display device is detected, the control part causes the display part to display each said advertising image.

7. The image display system according to claim 5, further comprising a deletion notification part configured to notify the image control apparatus of a deletion of the advertising image that has been downloaded.

8. The image display system according to claim 5, further comprising:
a detecting part configured to detect a position of the display device; and
a searching part configured to conduct a search for an image provider that is present within a prescribed range from said position,
wherein the control part causes the display part to display an advertising image for an image provider found in said search.

9. A method for displaying an image in a display device configured to display screens in three or more directions, the method comprising:
accessing an image control apparatus by using data for identifying a user of the display device, the image control apparatus being connected to a communication network to send an image to the display device;
selecting at least one image provider;
downloading, from the image control apparatus, an advertising image for each image provider selected in the selecting step;
storing the advertising image that has been downloaded; and
displaying the advertising image in either one or both of two directions out of the three or more directions.
